(19) United States
(12) Patent Application Publication
(10) Pub. No.: US 2020/0121025 A1
(43) Pub. Date: Apr. 23, 2020

(54) ODOR ELIMINATING PAD AND METHOD OF CONSTRUCTION

(71) Applicant: Zorpads Inc., New York, NY (US)

(72) Inventors: Jonathan Taylor WIEGELE, Venice, CA (US); Sierra SMITH, New York, NY (US)

(73) Assignee: Zorpads Inc., New York, NY (US)

(21) Appl. No.: 16/162,661

(22) Filed: Oct. 17, 2018

(51) Int. Cl. A43B 17/00; B32B 7/06; B32B 7/12; B32B 5/02; B32B 27/36; B32B 27/12; B32B 37/12; B32B 38/00; A43B 17/14; A43B 1/00; A43B 7/00

(52) U.S. Cl. CPC A43B 17/006; B32B 7/06; B32B 7/12; B32B 5/022; B32B 27/36; B32B 27/12; B32B 2437/02; B32B 38/0004; A43B 17/14; A43B 1/0045; A43B 7/00; B32B 2255/02; B32B 2307/758; B32B 37/12

(57) ABSTRACT

An activated-carbon based odor-eliminating pad and its method of construction are disclosed. The odor-eliminating pad is constructed out of multiple polyester layers over an activated-carbon layer. Preferably, one of the polyester layers is coated with an adhesive allowing the odor-eliminating pad to be removably attached to a surface. The odor-eliminating pad may be scented or unscented. The method of construction includes preparing both the activated-carbon layer, the polyester layers, as well as one or more adhesives for bonding the layers together, all before ultrasonically welding them together.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### CLAIM OF PRIORITY

This application does not claim priority to any patent or patent application.

### FIELD OF THE EMBODIMENTS

The field of the present invention and its embodiments relate to an odor eliminating pad and its method of construction. More particularly, the present disclosure relates to a highly-effective odor-eliminating pad for use on garments and accessories, and a scalable, cost-effective method of construction.

### BACKGROUND

The current market for shoe odor elimination products is shaped by businesses including Dr.Scholl's®, Odor Eaters™, and Sneaker Balls®. These brands have created uniquely designed products that eliminate shoe odors. However, one unmet need still persists in the shoe odor elimination market: namely, an adhesive, low-to-no-residue carbon filter pad that is long-lasting, discrete, unscented, antibacterial, disposable, one-size-fits-all, and that requires no modification prior to use. This need represents a long-felt but unfulfilled market gap.

Today, in effort to rid embarrassing and unpleasant shoe odors, people turn to brands such as Dr.Scholl's®, where they purchase Odor-X® Odor Fighting Insoles. However, this product has numerous shortcomings. First of all, it is not adhesive, causing the insole to uncomfortably bunch-up inside of the user's shoe. Additionally, this product is not one-size-fits-all and requires modification prior to use. Users must attempt to trim the insoles to achieve their desired size.

Individuals who recognize the drawbacks of Dr.Scholl's Odor-X® Odor Fighting Insoles may see the brand Odor-Eaters™ as a suitable alternative. OdorEaters® Spray Powder and Odor-Eaters® Powder are not desirable products as they are messier and thus less discrete than an adhesive pad. Specifically, the white sprays and powders eventually stain black insoles, and the fine white powder may accumulate inside of the shoe over time. Further, having powder in one's shoe can be uncomfortable after longer periods of wear.

In addition to sprays and powders, Odor-Eaters™ also makes insoles, including the Expanded Fit® Odor-Destroying Insoles, the Ultra-Durable® Odor-Destroying Insoles, the Ultra-Comfort® Odor-Destroying Insoles, the Soft & Slim® Odor-Fighting Insoles, and the Stink Stoppers® Odor-Blocking Insoles. Despite this ostensibly wide array of products, each of them has shortcomings causing them to fail to satisfy the aforementioned market demand. For example, none of them are adhesive or one-size-fits-all, and all of them require modification prior to use. Like with Dr.Scholl's® users, Odor-Eaters™ users are required to follow a cutting template to adjust the insoles to their shoe size. A related problem is that Odor-Eaters™ sizes only go up to a men's size eleven shoe.

Both of the preceding brands (i.e., Dr.Scholl's and Odor-Eaters™) build their products using an activated charcoal and baking soda mechanism. Accordingly, neither fills the market need for a product that eliminates odors using superior technology: activated carbon cloth. Carbonized rayon, an odor-absorbing tool that has been tested by NASA, is capable of absorbing 31 mg of odor per square inch. There is a need for an odor elimination product that uses this novel technology or other synthetic substrate possessing odor-absorbing properties such as those derived from phenolic resins.

Those who recognize the issues associated with Dr.Scholl's® and Odor-Eaters™ may see the brand and product Sneaker Balls® as a viable replacement. While Sneaker Bails® do not leave residue and can fit inside most shoes, they are not ideal for long-lasting odor elimination. Sneaker Balls® are simply air fresheners with which users can deodorize their shoes while they are not being worn. Thus, Sneaker Balls™ are not useful for individuals seeking to eliminate odors while playing sports or spending a long day on-the-go.

There remains a need for a shoe odor elimination device that is an adhesive, low-to-no-residue carbon filter pad that is long-lasting, discrete, unscented, antibacterial, disposable, one-size-fits-all, and that requires no modification prior to use. Currently, a way for a person to eliminate shoe odors with the described features is completely unavailable.

The present invention and its embodiments meet and exceed these objectives.

While these units may be suitable for the particular purpose employed, or for general use, they would not be as suitable for the purposes of the present disclosure as disclosed hereafter.

In the present disclosure, where a document, act, or item of knowledge is referred to or discussed, this reference or discussion is not an admission that the document, act, item of knowledge, or any combination thereof that was known at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed. It is contemplated that the claims may encompass one or more of the conventional technical aspects discussed herein.

### SUMMARY

An aspect of an example embodiment in the present disclosure is to provide an odor-eliminating pad that can be adhered to a surface and its method of construction. Accordingly, the present disclosure provides a method of constructing a plurality of odor-eliminating pads, which begins by providing a substrate having a first side and a second side, wherein the first side and the second side are coated with an adhesive, and wherein the adhesive on the first side is removably covered with a non-adhesive layer. The non-adhesive layer is preferably processed to allow for easy removal by an end-user. After that an odor-absorbing carbon layer is prepared from a rayon-based substance. In various embodiments other non-rayon-based, synthetic substances may be used to prepare the odor-absorbing carbon layer In order to be properly prepared, the rayon-based substance must be charred in a low-oxygen environment and subsequently activated. This activation can be done by steam or by acid etching.

At least one portion of polyester are then prepared by coating them with an adhesive and then treating each portion at a given temperature and pressure, where the temperature and pressure are kept constant or substantially constant, consistent, or substantially consistent through the treatment. In some embodiments, the adhesive is a rubber adhesive. Preferably, the adhesive has an adhesion of at least 0.33N-m. In some embodiments, the polyester portions are treated at a temperature within the range of 105° C. to 125° C., preferably within the range of 114° C. to 116° C., and more preferably at 115° C. In other embodiments, the polyester portions are treated at a pressure within the range of 3.5 BAR to 5.5 BAR, preferably within the range of 4.4 BAR to 4.6 BAR, and more preferably at a pressure of 4.5 BAR.

After the various layers have been prepared, one polyester layer is adhered to one side of odor-absorbing layer, and a second polyester layer is adhered to a second side of the odor-absorbing absorbing layer. Once the three layers are adhered together, the assembly is ultrasonically welded to provide for greater attachment between the layers. This welded assembly is cut into a plurality of odor-eliminating pads. Note that other non-woven fabrics such as polypropylene may be used instead of polyester.

In some embodiments, the odor-eliminating pad is impregnated with at least one powdered fragrance located between the first portion and the odor-absorbing carbon layer and with at least one powdered fragrance located between the second portion and the odor-absorbing carbon layer. Preferably, this powdered fragrance is constructed from a corn starch matrix with a fragrance imbued in said matrix. However, in some embodiments the odor-eliminating pad is coated with this powdered fragrance.

In addition to the method of construction, the present disclosure also contemplates a scented odor-eliminating pad, comprising a first fabric layer, having a first top side and a first bottom side, an odor-absorbing carbon layer constructed from an activated rayon or phenolic resin-based substrate having a top end and a bottom end, and a second fabric layer, having a second top side and a second bottom side. Preferably, the first bottom side and the top end are partially coated with a first adhesive, the bottom end and the second top side are partially coated with a second adhesive, and subsequently the first fabric layer, the odor-absorbing carbon layer, and the second fabric layer are then ultrasonically welded together. In many embodiments, the second bottom side is covered with an adhesive tape having a first side attached to the second bottom side and a second side covered with a removable relief liner, where the adhesive tape provides for the removable attachment of the odor-eliminating pad.

In various embodiments, one or more scents are applied to the odor-eliminating pad. This can be achieved by incorporating a powdered fragrance into the first adhesive and/or the second adhesive. Alternatively, this can be achieved by applying a powdered fragrance directly to the outermost layer. In other embodiments, a liquid fragrance is incorporated into the layer structure or within a packaging structure which houses the odor-eliminating pad.

The present disclosure addresses at least one of the foregoing disadvantages. However, it is contemplated that the present disclosure may prove useful in addressing other problems and deficiencies in a number of technical areas. Therefore, the claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### BRIEF DESCRIPTION OF THE PREFERRED EMBODIMENTS

In the drawings, like elements are depicted by like reference numerals. The drawings are briefly described as follows.

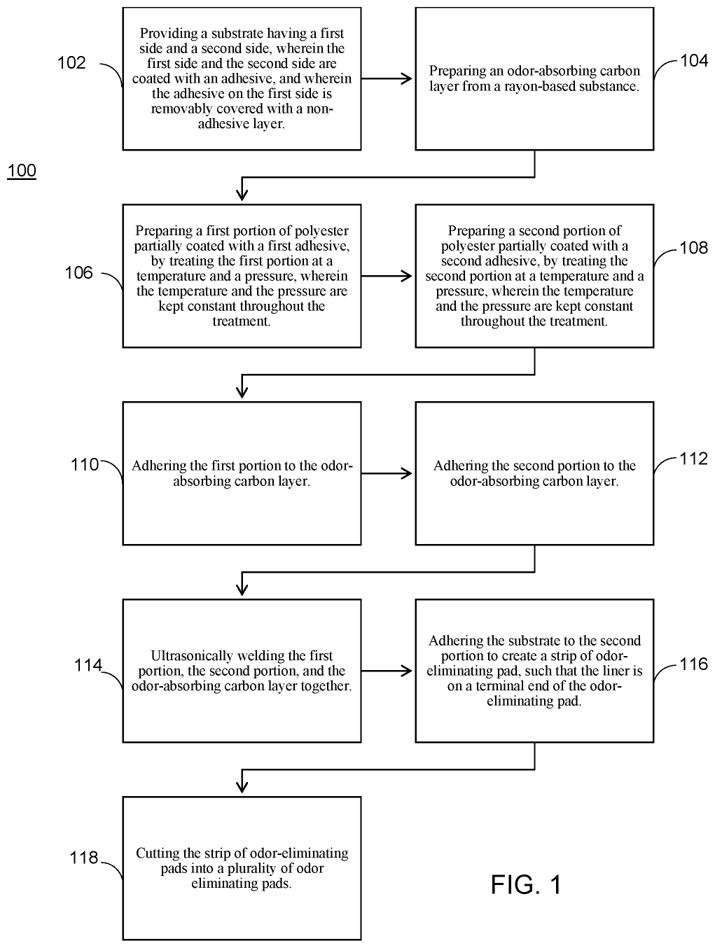

FIG. 1 is a flow chart showing an embodiment of the method of construction of an odor-eliminating pad in accordance with the present disclosure.

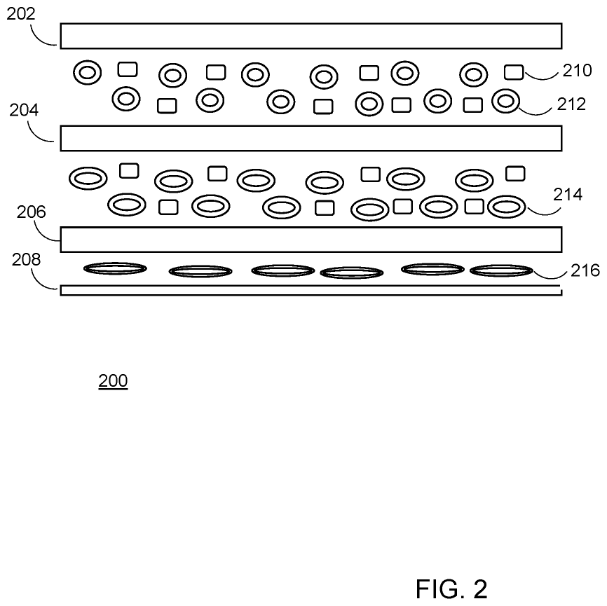

FIG. 2 is an exploded schematic view of an embodiment of a scented odor-eliminating pad in accordance with the present disclosure.

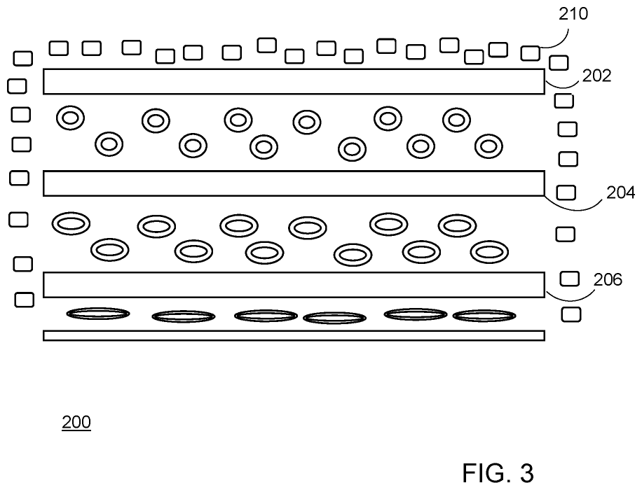

FIG. 3 is an exploded schematic view of a second embodiment of a scented odor-eliminating pad in accordance with the present disclosure.

The present disclosure now will be described more fully hereinafter with reference to the accompanying drawings, which show various example embodiments. However, the present disclosure may be embodied in many different forms and should not be construed as limited to the example embodiments set forth herein. Rather, these example embodiments are provided so that the present disclosure is thorough, complete, and fully conveys the scope of the present disclosure to those skilled in the art. In fact, it will be apparent to those skilled in the art that various modifications and variations can be made in the present invention without departing from the scope or spirit of the invention.

### DETAILED DESCRIPTION OF THE PREFERRED EMBODIMENTS

FIG. 1 illustrates a flow chart showing an embodiment of a method of construction 100 of the odor-eliminating pad in accordance with the present disclosure. This embodiment of the method of construction 100 begins with step 102, where a substrate having a first side and a second side is provided. Both the first side and the second side are coated with an adhesive, and a non-adhesive layer is removably attached to the adhesive coating the first side. While many adhesives are suitable for this purpose, in a highly preferred embodiment, the adhesive used is Decker Product #421, sold by Decker Tape Products, Inc. in Fairfield, N.J. specially formulated for use in high-humidity environments. Other embodiments exist where various no-residue adhesives are used. Water-based adhesives are not suitable for use in accordance with the present disclosure. In some embodiments, a split is formed in the non-adhesive layer to facilitate the removal process by the end-user.

In step 104, the method calls for the preparation of an odor-absorbing carbon layer from a rayon- or phenolic resin-based substrate. Preferably, the odor-absorbing carbon layer will be an activated carbon cloth created by charring the rayon- or phenolic resin-based substrate in a low-oxygen environment and subsequently activating the substrate by either steam or acid-etching. The method 100 then proceeds to step 106, where the first portion of polyester is prepared. Note that while polyester is a preferred fabric, other non-woven fabrics are also suitable such as polypropylene. In step 106, the first polyester portion is prepared by partially coating the polyester with a first adhesive and then treating the combination at a substantially consistent temperature and pressure for a predetermined amount of time. Preferably, this predetermined amount of time is in the range of 0.2 to 5 seconds. In some embodiments, the temperature is in the range of 105° C. to 125° C. In other, preferred embodiments, the temperature is in the range of 114° C. to 116° C. In a highly preferred embodiment, the temperature is 115° C. In various embodiments, the pressure is in the range of 3.5 BAR to 5.5 BAR, with a preferred range of 4.4 BAR to 4.6 BAR. In an exemplary embodiment, the pressure is 4.5 BAR. Preferably, the adhesive will be coated on the polyester in a dot patterns, although a specific pattern is not mandatory. In step 108, a second portion of polyester is prepared in the same manner as the polyester was prepared in step 106. Note that various embodiments exist without including the second portion of polyester.

After the first portion and the second portion of polyester have been prepared in steps 106 and 108, the method 100 proceeds to step 110 where the first portion is adhered to one side of the odor-absorbing carbon layer, preferably through mechanical force engaging the adhesive on the polyester. In step 112, the second portion is adhered to a second side of the odor-absorbing carbon layer, again preferably through mechanical force engaging the adhesive on the polyester. After the first portion of polyester, the odor-absorbing carbon layer, and the second portion of polyester have been adhered to each other, the entire combination is ultrasonically welded together in step 114. This is done to provide additional strength to the odor-eliminating pad.

In step 116, the substrate of step 102 is adhered to the second portion of polyester so that the odor-eliminating pad may be attached to something, such as the interior of an end-user's shoe. Finally, in step 118, the assembly generated by the previous steps is cut into smaller portions to be a more suitable size for use by the end-user.

Referring to FIG. 2, an exploded schematic view of a scented odor-eliminating pad 200 in accordance with the present disclosure is shown. Here, the scented odor-eliminating pad 200 is constructed out of a first fabric layer 202 having a first top side and a first bottom side, an odor-absorbing carbon layer 204 having a top end and a bottom end, a second fabric layer 206, and an adhesive tape 208. The first fabric layer 202 and the odor-absorbing carbon layer 204 are attached via a first adhesive 212 located in between the first bottom side and the top end. In this embodiment, a powdered fragrance 210 is located proximately to the first adhesive 212 such that it gets trapped between the first fabric layer 202 and the odor-absorbing carbon layer 204. In this embodiment, the powdered fragrance is also located proximately to the second adhesive 214, which is attached to the bottom end and the second top side. Note that in various embodiments the powdered fragrance 210 can be located proximately to either the first adhesive 212 or the second adhesive 214. The second bottom side of the second fabric layer 206 is attached to the adhesive tape 208, which is equipped with a removable liner. Preferably, the scented odor-eliminating pad is ultrasonically welded together to provide for greater strength and durability.

While many powdered fragrances are suitable for use as the powdered fragrance 210, preferably a corn starch matrix with a fragrance dissolved therein is highly preferred. In various embodiments, the first fabric layer 202 and the second fabric layer 206 are constructed out of polyester and the first adhesive 212 and the second adhesive 214 are Decker Product #421, sold by Decker Tape Products, Inc. in Fairfield, N.J. Other embodiments exist where various no-residue adhesives are used. Water-based adhesives are not suitable for use in accordance with the present disclosure. Further embodiments exist where the odor-absorbing carbon layer is an activated carbon cloth created from a phenolic resin-based substance.

Referring to FIG. 3, an exploded schematic view of an alternate embodiment of the scented odor-eliminating pad 200 is shown. Here, the scented odor-eliminating pad 200 also is comprised of the first fabric layer 202, the second fabric layer 206, and the odor-absorbing carbon layer 204 attached by an adhesive. Contrasted with the embodiment of FIG. 2, here, the powdered fragrance 210 is located on the outside of the scented odor-eliminating pad 200.

In a preferred embodiment, the scented odor-eliminating pad has an outside edge that is sealed together. In an alternative embodiment, the scented odor-eliminating pad only has a single fabric layer.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented an odor-eliminating pad and its method of construction. The disclosure is illustrated by example in the drawing figures, and throughout the written description. It should be understood that numerous variations are possible while adhering to the inventive concept. Such variations are contemplated as being a part of the present disclosure.

What is claimed is:

1. A method of constructing a plurality of odor-eliminating pads, comprising the steps of:
providing a substrate having a first side and a second side,
wherein the first side and the second side are coated with an adhesive, and
wherein the adhesive on the first side is removably covered with a non-adhesive layer;
preparing an odor-absorbing carbon layer from a rayon-based substance;
preparing a first portion of a non-woven thermoplastic material partially coated with a first adhesive, by treating the first portion at a temperature and a pressure,
wherein the temperature and the pressure are kept substantially consistent throughout the treatment;
adhering the first portion to the odor-absorbing carbon layer;
ultrasonically welding the first portion and the odor-absorbing carbon layer together creating a strip of odor-eliminating pads; and
cutting the strip of odor-eliminating pads into the plurality of odor eliminating pads.

2. The method of claim 1, wherein the adhesive is a rubber adhesive.

3. The method of claim 1, further comprising the steps of:
preparing a second portion of a non-woven thermoplastic material partially coated with a second adhesive, by treating the second portion at a temperature and a pressure, wherein the temperature and the pressure are kept substantially consistent throughout the treatment;
adhering the second portion to the odor-absorbing carbon layer; and
adhering the substrate to the second portion, such that the non-adhesive layer is on a terminal end of the odor-eliminating pad,
wherein the step of “ultrasonically welding the first portion, and the odor-absorbing carbon layer together creating a strip of odor-eliminating pads” is replaced with “ultrasonically welding the first portion, the second portion, and the odor-absorbing carbon layer together creating a strip of odor-eliminating pads.”

4. The method of claim 2, wherein the adhesive has an adhesion of at least 0.33 N-m.

5. The method of claim 1, wherein the temperature is within the range of 114° C. to 116° C.

6. The method of claim 5, wherein the temperature is 115° C.

7. The method of claim 1, wherein the pressure is substantially 4.5 BAR.

8. The method of claim 1, where the step of preparing an odor-absorbing carbon layer from a rayon-based substance comprises the steps of:
providing the rayon-based substance; and
charring the rayon-based substance in a low-oxygen environment;
activating the charred rayon-based substance.

9. The method of claim 8, wherein the charred rayon-based substance is activated with steam.

10. The method of claim 8, wherein the charred rayon-based substance is activated with acid etching.

11. The method of claim 1, further comprising the steps of:
impregnating the odor-eliminating pad with at least one powdered fragrance located between the first portion and the odor-absorbing carbon layer and with at least one powdered fragrance located between the second portion and the odor-absorbing carbon layer.

12. The method of claim 1, wherein the powdered fragrance comprises a corn starch matrix with a fragrance imbued in said matrix.

13. The method of claim 1, further comprising the step of:
coating the odor-eliminating pad with at least one powdered fragrance.

14. The method of claim 1, further comprising the step of:
processing the non-adhesive layer to create at least one split in the layer while preventing the adhesive on the first side from exposure.

15. A scented odor-eliminating pad, comprising:
a first non-woven thermoplastic material layer, having a first top side and a first bottom side;
an odor-absorbing carbon layer constructed from an activated rayon-based substrate having a top end and a bottom end; and
a second non-woven thermoplastic material fabric layer, having a second top side and a second bottom side,
wherein the first bottom side and the top end are partially coated with a first adhesive,
wherein the bottom end and the second top side are partially coated with a second adhesive,
wherein the first non-woven thermoplastic material layer, the odor-absorbing carbon layer, and the second non-woven thermoplastic material layer are ultrasonically welded together,
wherein the second bottom side is covered with an adhesive tape having a first side attached to the second bottom side and a second side covered with a removable relief liner, and
wherein the adhesive tape provides for the removable attachment of the odor-eliminating pad.

16. The scented odor-eliminating pad of claim 15, wherein a scent has been applied to the odor-eliminating pad.

17. The scented odor-eliminating pad of claim 15, wherein a powdered fragrance is incorporated into the first adhesive and the second adhesive.

18. The scented odor-eliminating pad of claim 16, wherein a powdered fragrance is applied directly to the outermost layer.

19. The scented odor-eliminating pad of claim 16, wherein a liquid fragrance is incorporated into in between the first non-woven fabric layer, the odor-absorbing carbon layer, and the second non-woven fabric layer.

20. The scented odor-eliminating pad of claim 16, wherein a liquid fragrance is incorporated into a packaging structure which houses the pad.
